(19) United States
(12) Patent Application Publication
(10) Pub. No.: US 2012/0006759 A1
(43) Pub. Date: Jan. 12, 2012

(54) Method and system for removal of trihalomethane from water supplies

(76) Inventors: Ethan Brooke, Biddeford, ME (US); M. Robin Collins, Lee, NH (US)

(21) Appl. No.: 13/135,666

(22) Filed: Jul. 12, 2011

Related U.S. Application Data
(60) Provisional application No. 61/363,401, filed on Jul. 12, 2010.

(51) Int. Cl. C02F 1/74; B01F 3/04

(52) U.S. Cl. 210/758; 261/34.1; 261/127

(57) ABSTRACT

A method of and system for treating water to reduce the level of trihalomethanes includes the water to be treated (WTBT) being sprayed through a nozzle to aerate the WTBT to increase the air/water interface therein reducing the level of trihalomethanes in the water. In one embodiment, the pressure of the WTBT in the nozzle is adjusted and the nozzle is selected to have a nozzle orifice such that the droplet size of the water to be treated from the nozzle is less than 150 microns SMD. In addition, the nozzle is spaced from a holding tank for receiving and collecting the sprayed water such that the surface of the treated water is a minimum of four meters from the nozzle.

### CROSS-REFERENCE TO RELATED APPLICATIONS

The present application claims the benefit of Provisional Patent Application Ser. No. 61/363,401 filed Jul. 12, 2010, which is incorporated herein by reference.

### TECHNICAL FIELD OF THE INVENTION

The present invention is a method and system for removal of trihalomethane from water. More specifically, it is a method and system for using spray aeration for removing trihalomethanes from a water supply.

### BACKGROUND OF THE INVENTION

Trihalomethanes (THMs) are formed as a by-product when chlorine or bromine is used to disinfect water for drinking. Trihalomethanes are chemical compounds in which halogens replace three of the four hydrogen atoms of methane (CH₄). Halogen is an element from the group that includes fluorine (F), chlorine (Cl), bromine (Br), iodine (I), and astatine (At). Some of the common trihalomethanes found in water are Choloform (tricholoromethane CHCl₃), Dibromochloromethane (CHBr₂Cl), Bromodichloromethane (CHBrCl₂), and Bromoform (tribromomethane CHBr₃).

There have been some studies such as a California study that suggest a link between miscarriages and disinfection by-products (DBP) of THM in drinking water. The U.S. Environmental Protection Agency (EPA) in recent years has increased the standard related to THM therein reducing the amount of THM in parts per billion (ppb).

However, water systems, such as public water systems, need to balance several factors in the treatment of water. Some water systems, such as small public water systems, may obtain water from neighboring systems resulting in the water being in the distribution system for longer time periods. This longer time period may result in more disinfection by-products (DSP) such as THMs.

### SUMMARY OF THE INVENTION

In contrast to conventional systems, the system and method of the instant invention reduces the level of trihalomethanes at minimum cost including both operation and maintenance costs, works well in both large scale and small scale systems, and can take existing system and modify without requiring major infrastructure expansion.

According to the invention, a method of treating water to reduce the level of trihalomethanes includes spraying the water through a nozzle to aerate the water to be treated to increase the air/water interface therein reducing the level of trihalomethanes in the water.

In an embodiment, the nozzle is spaced from a holding tank for receiving and collecting the sprayed water therein increasing the air/water interface by increasing the time the air/water interface occurs therein reducing the level of trihalomethanes in the water.

In an embodiment, the water to be treated is heated to a temperature in the range of 4° C. to 90° C. to reduce the level of trihalomethanes in the water. In an embodiment, the water to be treated is heated to a temperature in the range of 15° C. to 90° C. to reduce the level of trihalomethanes in the water. In an embodiment, the water to be treated is heated to a temperature in the range of 35° C. to 50° C. to reduce the level of trihalomethanes in the water. In an embodiment, the water to be treated is at ambient temperature.

In an embodiment, the nozzle is selected to have a nozzle orifice and the pressure of the water to be treated is adjusted such that the droplet size of the water to be treated from the nozzle is less than 1200 microns Sauter mean diameter (SMD). In an embodiment, the nozzle is selected to have a nozzle orifice and the pressure of the water to be treated is adjusted such that the droplet size of the water to be treated from the nozzle is less than 400 microns SMD. In an embodiment, the nozzle is selected to have a nozzle orifice and the pressure of the water to be treated is adjusted such that the droplet size of the water to be treated from the nozzle is less than 150 microns SMD.

In an embodiment of a method of treating water to reduce the level of trihalomethanes, the water to be treated is pumped in a pipe from a reservoir to a nozzle. The water to be treated is heated in the pipe such that the temperature of the water to be treated at the nozzle is in the range of 35° C. to 65° C. The pressure of the water to be treated is adjusted in the nozzle. The nozzle is selected to have a nozzle orifice such that the droplet size of the water to be treated from the nozzle is less than 150 microns SMD. The nozzle is spaced from a holding tank for receiving and collecting the sprayed water such that the surface of the treated water is a minimum of four meters from the nozzle. This results in the air/water interface being such that the level of trihalomethanes is reduced from the water to be treated to the treated water.

In an embodiment of a drinking water treatment system for reducing the level of trihalomethanes in the water to be treated, the system has a reservoir for containing the water to be treated. The system has a nozzle for spraying the water to be treated and a pipe for carrying the water to be treated from the reservoir to the nozzle. A holding tank receives the treated water. A pump pumps the water from the reservoir to the nozzle. The nozzle has an orifice that is selected in conjunction with the pump to create a pressure such that the droplet size formed by the nozzle is less than 400 microns SMD.

In an embodiment, the system has a heating system for heating water to be treated to a minimum of 30° C.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic of a system for removing trihalomethanes (THM) according to the invention;

FIG. 2A and FIG. 2B are graphs showing the removal of various species of THM as a function of the air to water ratio at 20° C. and 1° C. respectively.

FIG. 3 is a graph of actual predicted percent removals of THM v. removal of THMs at 20° C.

FIG. 4A is a schematic of a spray cone area;

FIG. 4B is a schematic of the cone showing the average droplet travel distance;

FIG. 4C is a schematic of the volumetric ratio of droplet path;

FIG. 5A is a graph of percent removal of chloroform (CF) versus air-to-water ratio for spray aeration;

FIG. 5B is a graph of percent removal of dichlorobromomethane (DCBM) versus air-to-water ratio for spray aeration;

FIG. 5C is a graph of percent removal of chlorodibromomethane (CDBM) versus air-to-water ratio for spray aeration; and

FIG. 5D is a graph of percent removal of bromoform (BF) versus air-to-water ratio for spray aeration.

### DETAILED DESCRIPTION OF THE INVENTION

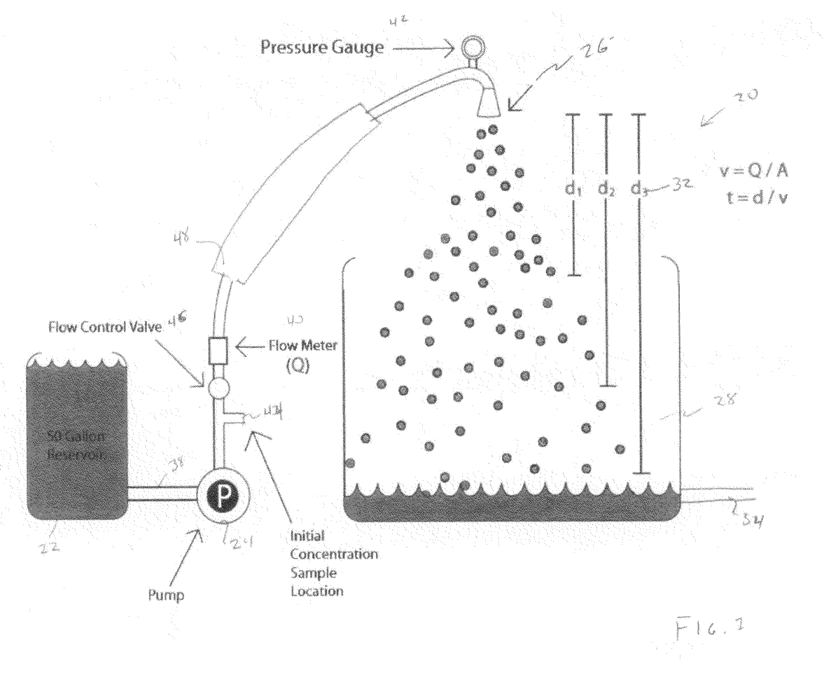

The present invention is a system 20 and a method for treating water to reduce levels of trihalomethanes. Referring to FIG. 1, a schematic of a system 20 for removing trihalomethanes (THM) according to the invention is shown. The system 20 has a water input as represented by the reservoir 22. The reservoir 22 contains drinking water 18 that has been treated by disinfectants such as chlorine or bromine. The drinking water, the water to be treated (WTBT), 18 is drawn from the reservoir 22 by a pump 24 to an aeration spray head or nozzle 26. The aerator spray head 26 is located above a holding tank 28 having THM-reduced drinking water, the treated water, 30. The treated drinking water 30 is shown having a distance 32 below the aerator spray head 26. The holding tank 28 has an outlet pipe 34 for removing water from the holding tank 28. The outlet pipe 34 may go to the drinking water system 36 or another holding tank. The water flows from the reservoir 22 to the aerator spray head 26 through a pipe 38. In addition to passing through the pump 24, the pipe 38 has various monitoring systems including a flow monitor 40 and a pressure monitor or gauge 42 and a sample taking location 44. In addition, the system 20 has a flow control valve 46 that influence the drinking water 18 as it flows through the pipe 38. In an embodiment, the system 20 in addition has a heater unit 48 for adjusting the temperature of the drinking water 48 during treating.

In a prototype, varying operating conditions and design variables were tested. Table I and Table II show the variables.

TABLE I
Initial Spray Aeration Design and Operating Variables

| | Level 1 | Level 2 | Level 3 | Level 4 |
|---|---|---|---|---|
| Operating Conditions | | | | |
| TTHM Concentration (ug/L) | 50 | 125 | 200 | 400 |
| Design Variables | | | | |
| Nozzle Type | 1 | 2 | | |
| Operating Pressure (PSI) | 2 | 20 | | |

TABLE II
Spray Aeration Pilot Scale Optimization
Trials Operating and Design Variables

| | Level 1 | Level 2 | Level 3 | Level 4 |
|---|---|---|---|---|
| Operating Conditions | | | | |
| Water Temperature (c.) | 1 | 22 | 36 | |
| Design Variables | | | | |
| Droplet Travel Distance (m) | 0.74 | 2.13 | 4.27 | |
| Droplet SMD (u) | 140 | 350 | 690 | 1100 |

In the prototype, a pilot scale experimental apparatus of the system 20 consisted of a 55 gallon drum representing the reservoir 22 connected to a 1.5 hp centrifugal pump 24 manufactured by Sta-Rite inc, model number 1f98V. An initial concentration sample location consisting of a ball valve connected to ⅛ inch diameter tubing was located immediately after the pump 24. In contrast to the real world where the drinking water 18 that is sent to the reservoir 22 already contains the THM, the THM was introduced at the sample taking location 44 of FIG. 1. The water used in the pilot scale optimization trials was reverse osmosis filtered (RO) water. The RO water was tested for chlorine using a hatch chlorine pocket spectrometer test kit and was found to have 0.00 mg/L of chlorine.

All THM concentration analysis was conducted using the modified version of EPA method 551.1. The electron capture gas chromatograph used in analysis was an Agilent Technologies 6890N GC-ECD, fitted with an Agilent 7683 Series auto sampler and auto injector. Included with each batch of samples was a lab-created spiked sample for calibration. The squared correlation coefficient (R2) for spiked samples (provided by the lab) was greater than 0.99 for all four species of THMs, indicating satisfactory analytical accuracy.

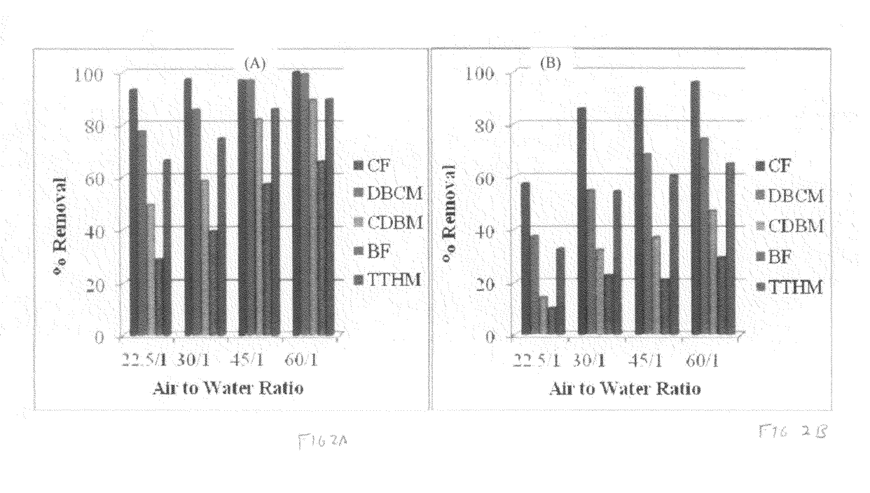

Referring to FIGS. 2A and 2B, the percent removals of each THM species versus air to water ratio at one degree Celsius and twenty degrees Celsius is shown. Air to water ratio had a significant effect on THM concentration, with THM removal rates increasing proportionally to an increasing air to water ratio as seen in FIGS. 2A and 2B. The influence of Henry's constant for the particular THM species on achieved removals was also significant. Chloroform having the highest Henry's constant was the species most amenable to removal by aeration followed in order of descending Henry's constants by chlorodibromomethane, bromodichloromethane, and bromoform.

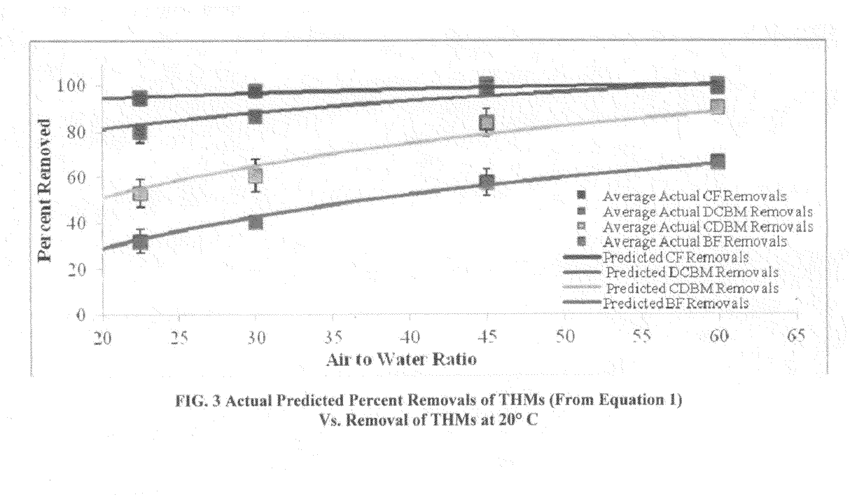

In order to design a spray aeration system based on operating conditions and treatment objectives, several diffused aeration models based on a minimum air to water ratio were evaluated. Diffused aeration is where bubbles of air, pass through liquid versus spray aeration where droplets of liquid pass through air. The one that best matched experimental results is shown in Equation 1. Predicted and empirical results are shown in FIG. 3. It should be noted that this equation is specific to batch mode aeration.

$$\begin{matrix}\begin{matrix}\begin{matrix}\begin{matrix}ln {C}_{C} = - ( \frac{{H}_{CC} \dot{V}}{{V}_{W}} \cdot t ) + ln {C}_{O} \\ {C}_{O} = Initial Concentration\end{matrix} \\ {C}_{C} = Effluent Concentration\end{matrix} \\ {H}_{CC} = Henrys Constant\end{matrix} \\ \dot{V} = Air Flow Rate \\ {V}_{W} = Water Volume \\ t = Time\end{matrix} \qquad ( 1 )$$

While the testing was done with diffused aeration, diffused and spray aeration rely on the same mechanisms for mass transport; a concentration gradient drives the THMs through an interfacial surface area, moving the THMs from a liquid phase to a gas phase. The key difference between diffused and spray aeration is that the bubbles created in diffused aeration have a finite volume and can reach saturation rapidly. This means that THM removal may only occur for the first few feet of bubble contact. Because bubbles have a small volume, the gas concentration of THMs inside the bubbles increases over time, lessening the concentration gradient that provides the driving force for mass transfer. Spray aeration offers a larger air volume, greatly lessening the effect of a decreasing concentration gradient, and therefore offering the potential for a more efficient aeration strategy. Like a diffused aeration apparatus, a spray aerator could be placed in either a water tower or a clear well chlorine contact chamber.

In diffused aeration, air is compressed and blown up through the water column; therefore for tall tanks creating enough air pressure to overcome the water pressure can become cost prohibitive. Diffused aeration is not recommended for depths greater than 1 feet, which diminishes the number of tanks in which this treatment technology would be useful.

Finally, spray aeration requires water pressure to make an air to water interface, while diffused aeration requires air pressure. Because water pressure is already required for filling a water tank, the instant invention recognized that some systems 20 may require nothing more than a redesign of water tank influent piping and the addition of a spray nozzle 26 in order to realize significant THM reductions.

The spray aeration pilot scale experiments focused on an assessment of operating and design variables affecting THM removal rates with an emphasis on gathering enough information to accurately create a model which could be utilized to design and build an actual spray aeration apparatus in the field. With that goal in mind, all design and operating variables were chosen to either reflect likely worst case operating conditions, or design variables identified as likely to influence THM removals. Design and operating variables for the spray aeration pilot scale optimization trails are summarized in Table III.

TABLE III
Spray Aeration Pilot Scale Optimization
Trials Operating and Design Variables

| | Level 1 | Level 2 | Level 3 | Level 4 |
|---|---|---|---|---|
| Operating Conditions | | | | |
| Water Temperature (c.) | 1 | 22 | 36 | |
| Design Variables | | | | |
| Droplet Travel Distance (m) | 0.74 | 2.13 | 4.27 | |
| Droplet SMD (u) | 140 | 350 | 690 | 1100 |

In the prototype, for the spray aeration pilot scale optimization experimental trials, spray nozzles from nozzle manufacturer BETE were selected (http://www.bete.com). These nozzles 26 were chosen because the nozzles 26 are able to produce a wide variety of droplet sizes (based on nozzle type and operating pressure) but have only one nozzle orifice. This was considered a design advantage because the large opening should help to prevent nozzle clogging. The second design variable selected for this experiment was droplet travel distance; the distance a droplet travels after exiting the nozzle 26 before splashing down onto the water surface. This was considered an important variable because the time it takes the droplet to travel from the nozzle exit to the water surface 50 is the time in which mass transfer can occur. By varying the droplet travel distance and keeping the nozzle exit velocity and droplet SMD constant, an assessment of the influence of air to water contact time was evaluated. The experimental apparatus shown in FIG. 1 was used. The average initial THM concentration before aeration was 112 ug/L. The influence of the spray aeration pilot scale experimental factors is summarized in Table IV.

TABLE IV
Influence of Spray Aeration Pilot Scale
Experimental Factors on TTHM Removals

| Parameter | CF | DCBM | CDBM | BF | TTHM |
|---|---|---|---|---|---|
| Droplet Travel Distance | 34.38758 | 36.06 | 33.55 | 29.89 | 33.11 |
| Temperature | 18.73616 | 16.64 | 17.64 | 18.25 | 18.71 |
| Sauter Mean Diameter | 12.57438 | 12.80 | 15.29 | 18.56 | 14.24 |
| of Droplet | | | | | |
| Droplet Travel | 7.578491 | 7.57 | 6.03 | 6.46 | 6.89 |
| Distance * Temperature | | | | | |
| Error | 26.72339 | 26.93 | 27.49 | 26.84 | 27.05 |

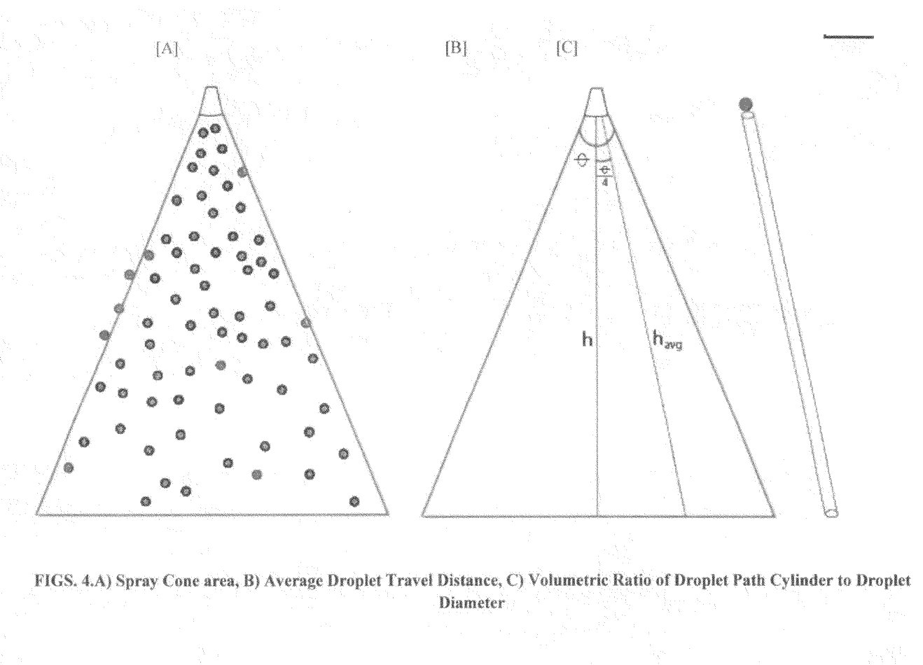

FIG. 4A shows a schematic of a spray cone area. As a water droplet falls, the space it moves through has a volume and can be visualized as a long cylinder with a height (h) equal to the average distance the droplet travels from nozzle exit to splash down and a diameter (d) equal to the average droplet diameter as seen in FIG. 4B. The average droplet travel distance has been assumed to be equal to a droplet travel path half way between the maximum droplet travel distance at the exterior of the spray cone and the smallest droplet travel distance, at the center of the spray cone. This ratio of volumetric interfacial ratio, shown in equation 2 is analogous to an air to water ratio used in counter current packed towers or diffused aeration.

$$Ratio of Volumetric Interfacial Areas = \frac{\frac{π {d}^{2} {h}_{avg}}{4}}{\frac{π {d}^{3}}{6}} = \frac{1.5 {h}_{avg}}{d} \\ d = Droplet Sauter Mean Diameter \\ {h}_{avg} = Average Droplet Travel Distance \qquad ( 2 )$$

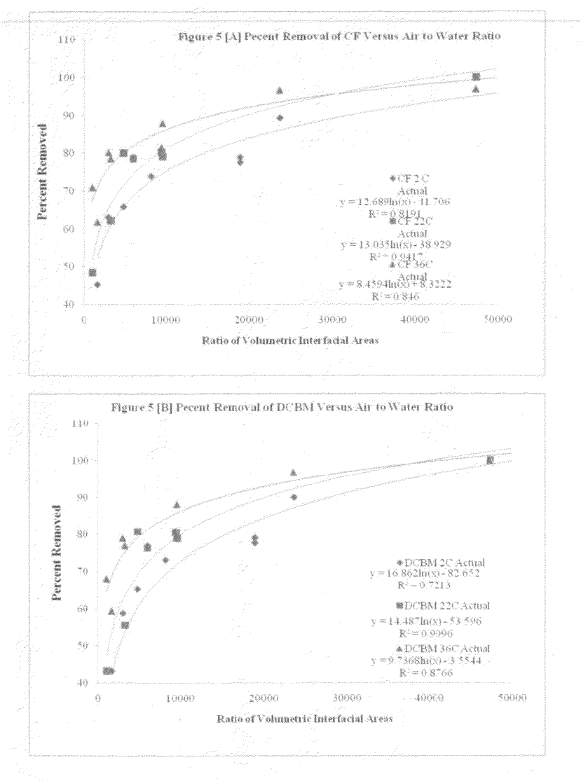

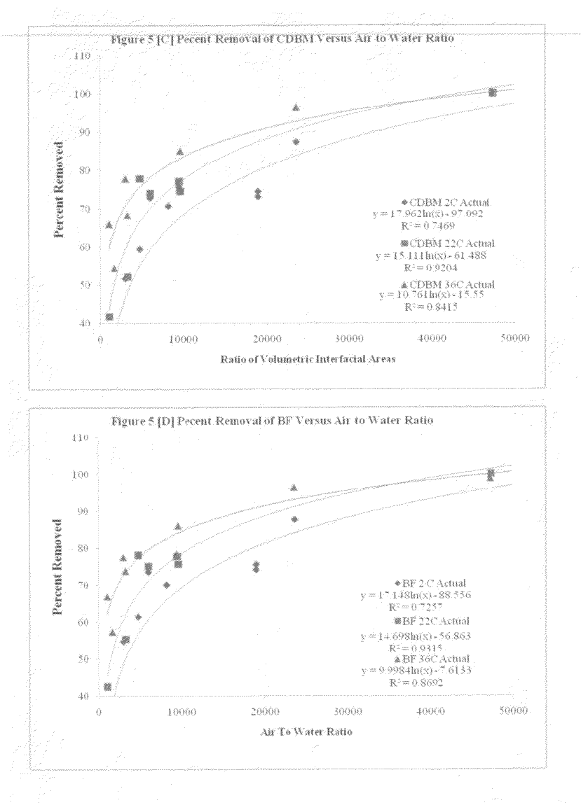

By comparing the volumetric ratio to the percent removals achieved, a set of design graphs for each species of THM, FIGS. 5A-5D, has been created. These design graphs are potentially useful to the design engineer because operating variables such as THM speciation and required percent reduction, droplet travel distance (based on storage tank dimensions and pumping regime), and operating temperature range are usually known variables. Based on that information, the required droplet diameter for a spray aeration apparatus can be calculated using the information in FIGS. 5A-5D. The graphs were created by experimental determine several points and generating lines that are “best fit” to the data points. The R² valves describe how well the line fits the data.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed is:

1. A method of treating water to reduce the level of trihalomethanes, the method comprising:
spraying a water through a nozzle to aerate the water to be treated to increase the air/water interface therein reducing the level of trihalomethanes in the water.

2. A method of treating water of claim 1 further comprising spacing the nozzle from a holding tank for receiving and collecting the sprayed water therein increasing the air/water interface by increasing the time the air/water interface occurs therein reducing the level of trihalomethanes in the water.

3. A method of claim 1 where the water is heated to a temperature in the range of 4° C. to 90° C. to reduce the level of trihalomethanes in the water.

4. A method of claim 3 where the water is heated to a temperature in the range of 15° C. to 90° C. to reduce the level of trihalomethanes in the water.

5. A method of claim 4 where the water is heated to a temperature in the range of 35° C. to 50° C. to reduce the level of trihalomethanes in the water.

6. A method of claim 1 further comprises selecting the nozzle with a nozzle orifice and adjusting the pressure of the water to be treated such that the droplet size of the water to be treated from the nozzle is less than 5000 microns Sauter mean diameter (SMD).

7. A method of claim 6 wherein the selection of the nozzle with a nozzle orifice and adjusting the pressure of the water to be treated is such that the droplet size of the water to be treated from the nozzle is less than 1200 microns SMD.

8. A method of claim 6 wherein the selection of the nozzle with a nozzle orifice and adjusting the pressure of the water to be treated is such that the droplet size of the water to be treated from the nozzle is less than 400 microns SMD.

9. A method of claim 6 wherein the selection of the nozzle with a nozzle orifice and adjusting the pressure of the water to be treated is such that the droplet size of the water to be treated from the nozzle is less than 150 microns SMD.

10. A method of treating water to reduce the level of trihalomethanes, the method comprising:
pumping the water to be treated in a pipe from a reservoir to a nozzle;
adjusting the pressure of the water to be treated in the nozzle and selecting the nozzle with a nozzle orifice such that the droplet size of the water to be treated from the nozzle is less than 150 microns SMD; and
spacing the nozzle from a holding tank for receiving and collecting the sprayed water such that the surface of the treated water is a minimum of four meters from the nozzle,
wherein the air/water interface is such that the level of trihalomethanes is reduced from the water to be treated to the treated water.

11. A drinking water treating system for reducing the level of trihalomethanes in a water to be treated, comprising:
a reservoir for containing water to treated;
a nozzle for spraying the water to be treated;
a pipe for carrying the water to be treated from the reservoir to the nozzle
a holding tank for receiving treated water; and
a pump for pumping the water from the reservoir to the nozzle, wherein the nozzle has an orifice that is selected in conjunction with the pump to create a pressure such that the droplet size formed by the nozzle is less than 400 microns SMD.

12. A drinking water treating system of claim 11 further comprising a heating system for heating water to be treated to a minimum of 30° C.
